(19) United States
(12) Patent Application Publication
(10) Pub. No.: US 2013/0248514 A1
(43) Pub. Date: Sep. 26, 2013

(54) HEATING DEVICE

(71) Applicants: CARDIF S.R.L., San Giovanni Lupatoto (VR) (IT); THERMO ENGINEERING S.R.L., Verona (IT)

(72) Inventor: ALDO STABILE, Crema (IT)

(73) Assignee: THERMO ENGINEERING S.r.L., Verona (IT)

(21) Appl. No.: 13/892,053

(22) Filed: May 10, 2013

Related U.S. Application Data
(63) Continuation of application No. 13/811,549.

(51) Int. Cl. H05B 3/10

(52) U.S. Cl. CPC H05B 3/10
USPC 219/540

(57) ABSTRACT

Heating device, including a flexible band provided with laminar conductor means crossed by current and suitable for diffusing heat into the environment and laminar insulating means associated with said laminar conductor means, wherein said conductor means includes a plurality of conducting strips, of smaller width than that of said flexible band, electrically connected to one another.

### CROSS REFERENCE TO RELATED APPLICATIONS

This application is a Continuation application of U.S. patent application Ser. No. 13/811,549 entitled “Heating Device,” which is the National Stage application under 35 U.S.C. 371 of International Application No. PCT/IB2010/053349 filed Jul. 22, 2010 and incorporated herein by reference in its entirety.

### TECHNICAL FIELD OF THE INVENTION

The present invention concerns a heating device.

More specifically, the present invention concerns a heating device consisting of a flexible band to be installed under the surface of a wall or of a floor.

### STATE OF THE ART

Heating devices consisting of flexible bands are known that comprise laminar conductor means that diffuse heat into the environment through the heating that they undergo when they are crossed by a suitable current, this heating being known as the Joule effect. The aforementioned conductor means, usually in the form of sheets or bands of aluminum of low thickness, are associated with laminar insulating means, which also take care of protecting them front the outside environment and that give the flexible band the necessary mechanical strength to be correctly installed and last a long time.

Such heating devices are usually installed below the surface of a wall or of a floor, and they are then connected to the electrical mains.

Known devices usually operate at low voltage, i.e., with a voltage of less than 48 V, and the conductor means are sized to operate with such a voltage: they are usually of a width almost equal to that of the flexible band, and therefore they have a certain electrical resistance that, connected to a low voltage, is crossed by a current suitably determined and calculated to heat a room of certain dimensions.

This choice is mainly due to reasons of safety in operation, since it is known that low voltage power supply involves less risk of accidents and damage to the device itself and to people.

However, since in rooms there is the conventional mains voltage—which internationally is 230 V—it is-necessary to associate the device with an electrical transformer, which takes care of supplying the conductor means of the device with low voltage, in a reliable and safe manner. However, the transformer is a component whose cost has a substantial impact upon the overall production cost of the device, and also clearly on the installation and maintenance cost thereof, since it must be suitably installed, it can be subject to breaking, etc.

Therefore, in order to obtain a substantial reduction in the cost of the device, there is a need to completely eliminate the transformer, whilst still keeping the characteristics and performance of the device itself unchanged in terms of its operating efficiency and effectiveness, as well as in terms of safety.

### SUMMARY OF THE INVENTION

The technical task of the present invention is therefore to devise a heating device that can be installed and made to work in rooms of any type without any transformer, i.e., with a simple and direct connection to the electrical mains.

In such a technical task, a purpose of the present invention is to make a device that can be installed in an of and safe manner.

This purpose is accomplished by the heating device according to the present principles.

The presence, in the same flexible band, of a plurality of conducting strips of lower width than that of the band and connected in series, makes it possible to obtain an electric circuit of resistance suitably calculated based, on the supply voltage available and the optimal electric power to be dissipated into the room in the form of heat, without therefore needing an electrical transformer.

Moreover, the flexible band is extremely manageable, strong and easy to install in any room even by unspecialised personnel.

Further advantageous characteristics are described in the dependent claims.

### BRIEF DESCRIPTION OF THE DRAWINGS

The characteristics of the invention will become clearer for any man skilled in the art from the following description and from the attached tables of drawings, given as a non-limiting example, in which:

FIG. 1 is a detailed perspective view of the heating device at the first end of the flexible band;

FIG. 2 is another perspective view, from a different angle, of the device at the first end of the flexible band, with the first terminal element partially dismounted;

FIG. 3 is another perspective view of the device at the first end of the flexible band, with other components removed;

FIG. 4 is a schematic perspective view of the electrical connection of the conducting strips;

FIG. 5 is a cross section of the heating device at the second end of the flexible band;

FIG. 6 is a perspective view of another embodiment of the heating device according to the invention, at the first end of the flexible band, with the first terminal element partially dismounted;

FIG. 7 is another perspective view of the device of FIG. 6 at the first end of the flexible band, with other components removed;

FIG. 8 is a schematic perspective view of the electrical connection of the conducting strips of the device of FIGS. 6,7;

FIG. 9 is a schematic perspective view of the electrical connection of the conducting strips of another embodiment of the device;

FIG. 10 is a schematic perspective view of the electrical connection of the conducting strips of yet another embodiment of the device;

FIG. 11 is a detailed and sectioned side view of one of the ends of the flexible band, in another embodiment of the device; and

FIG. 12 is a detailed and sectioned side view of one of the ends of the flexible band, in yet another embodiment of the device according to the invention.

### DETAILED DESCRIPTION OF EMBODIMENTS OF THE INVENTION.

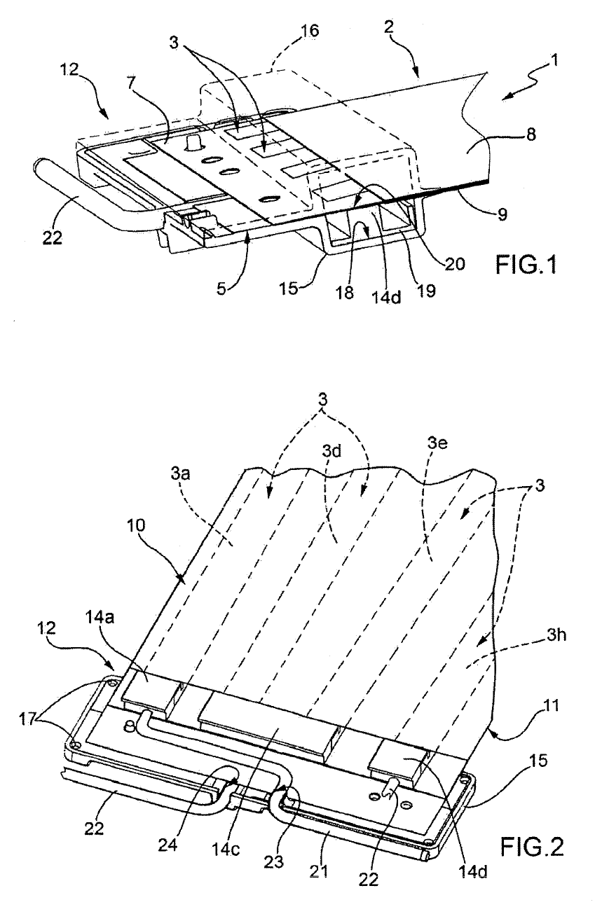

With reference to the attached FIG. 1, a heating device according to the present invention is wholly indicated with 1.

The heating device according to the present invention can be installed in any room, public or private, without any limitation, and it can be mounted under the surface of any wall or floor.

The device 1 comprises a flexible band, wholly indicated with 2, provided with laminar conductor means 3, which shall be described better hereafter. The laminar conductor means 3a, 3b, 3c, 3d, 3e, 3f, 3g, 3h are directly connected to the electrical mains, thus supplied with normal mains voltage, and therefore they are crossed by current so as to diffuse the heat, by the Joule effect, in the room in which the device is installed, for example a bedroom, a lounge, etc.

The flexible band 2 also comprises laminar insulating means, wholly indicated with 4 and of the per se known type, associated with the laminar conductor means 3 in the way that will be described hereafter.

The conductor means 3 comprise, in greater detail, a plurality of conducting strips 3a, 3b, 3c, 3d, 3e, 3f, 3g, 3h of smaller width than that of the flexible band 2, electrically connected in series to one another, with the technical advantages that will become clear hereafter.

The conducting strips 3a, 3b, 3c, 3d, 3e, 3f, 3g, 3h, in the embodiment described here, are eight in number, just as an example. Their number can of course be whatever in relation to the specific requirements, without any limitation.

The conducting strips 3a, 3b, 3c, 3d, 3e, 3f, 3g, 3h, that are made from sheets of aluminum with a thickness of a few microns—for example 10-12 microns—are electrically connected in series to one another at the ends 5, 6 of the flexible band 2.

The conducting strips 3a, 3b, 3c, 3d, 3e, 3f, 3g, 3h are in overlapping sets of two inside the flexible band 2.

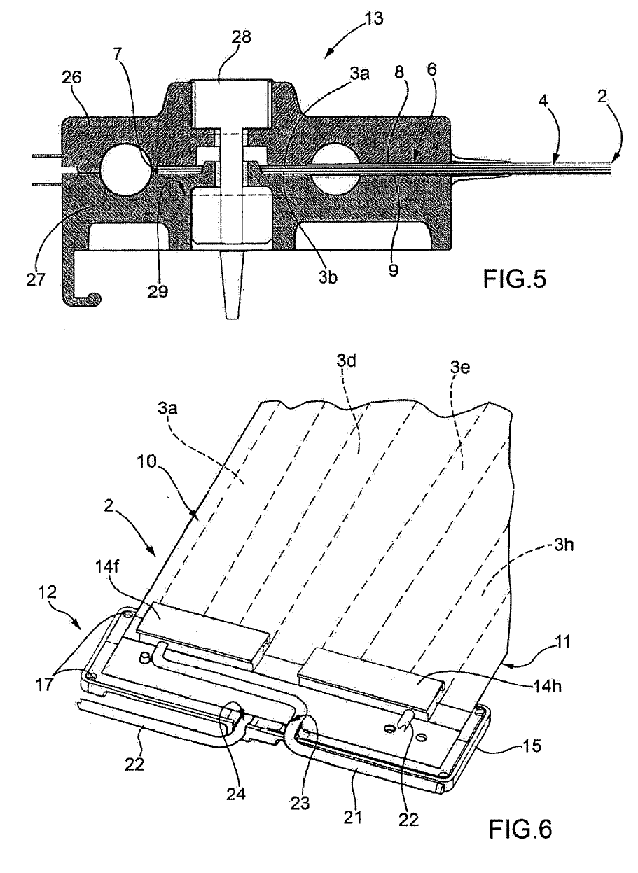

In order to obtain the necessary characteristics of electrical insulation and mechanical strength, the insulating laminar means 4 of the flexible band 2 comprise, in a per se known way that can be seen for example in FIG. 5, a central sheet 7, for example of polymeric material or similar, on the two faces of which the conducting strips 3a, 3b, 3c, 3d, 3e, 3f, 3g, 3h are arranged, parallel and in overlapping sets of two; on these strips, there are two further insulating sheets 8, 9 that make the first outer face 10 and the second outer face 11 of the flexible band 2.

The central sheet 7 and the insulating sheets 8, 9, as well as ensuring the optimal electrical insulation of the device, give the flexible band 2 the necessary mechanical strength to allow the device to be assembled. In order to carry out the installation of the latter, indeed, the flexible band 2 is laid out, for example, on the floor, and then is folded over on itself to make curves, so as to cover the overall surface of the room. The band 2, therefore, must withstand folds with very small radius of curvature without being damaged.

Each of the insulating sheets 7,8,9, in other embodiments, can in turn consists of overlapped sheets of different materials; there can be, outside and inside, other sheets or layers of other materials suitable for giving the band insulating properties, mechanical strength, protection from external agents, etc.

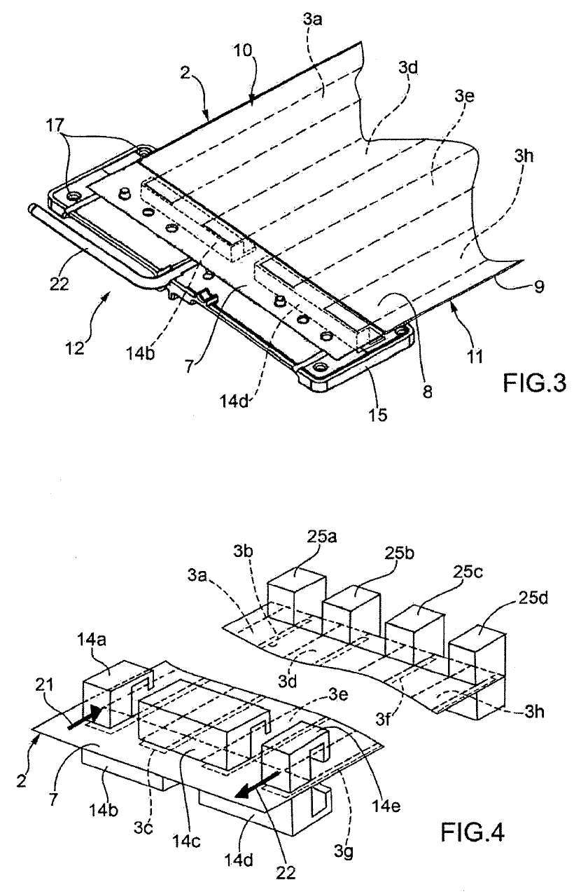

The device 1 comprises a first terminal element, wholly indicated with 12, for the electrical connection of the conducting strips 3a, 3b, 3c, 3d, 3e, 3f, 3g, 3h, fixed at the first end 5 of the flexible band 2. The first terminal element 12 is illustrated, in various details, in FIGS. 1, 2, 3.

Moreover, the device 1 comprises a second terminal element, wholly indicated with 13, for the electrical connection of the conducting strips 3a, 3b, 3c, 3d, 3e, 3f, 3g, 3h fixed at the second end 6 of the flexible band 2. The second terminal element 13 is illustrated in the section of FIG. 5.

The first terminal element 12 comprises, in greater detail, a plurality of first conductor bodies 14a, 14b, 14c, 14d, 14e for the electrical connection of the conducting strips 3a, 3b, 3c, 3d, 3e, 3f, 3g, 3h in series with one another, so that two overlapped strips are crossed by current going the opposite way to one another. In this way, there is almost total cancelling out of the electromagnetic field generated by the current that crosses the conducting strips 3a, 3b, 3c, 3d, 3e, 3f, 3g, 3h: there is therefore no electromagnetic pollution in the room in which the device is installed.

The number, dimensions and arrangement of the first conductor bodies 14a, 14b, 14c, 14d, 14e will be described hereafter.

The first terminal element 12 comprises a first half-shell 15 and a second half-shell 16, fixed to one another with removable attachment means, for example screws engaged in holes 17. In this way, the first half-shell 15 and the second half-shell 16 surround the opposite first face 10 and second face 11, respectively, of the flexible band 2, at the first end 5.

The first conductor bodies 14a, 14b, 14c, 14d, 14e are housed in respective first seats 18, foreseen in the first half-shell 15 and in the second half-shell 16, as can be seen in FIG. 1.

The first conductor bodies 14a, 14b, 14c, 14d, 14e, in particular, consist of metallic blocks that have respective widened portions 19 that engage in the first seats 18, and have respective flat surfaces 20 for making contact with the conducting strips 3a, 3b, 3c, 3d, 3e, 3f, 3g, 3h.

Two of the first conductor bodies 14a, 14b, 14c, 14d, 14e housed in the first terminal element 12 are connected to electrical power supply means, not represented in the figures, through electric cables 21, 22 that are introduced into the first terminal element 12 itself through respective channels 23, 24. In greater detail, the electric cables 21, 22 are directly connected to the electrical mains of the room in which the heating device is installed.

The first and the second half-shell 15, 16 of the first terminal element 12 are made, for example, from material like plastic, or another material of equivalent mechanical and electrical insulation characteristics.

The second terminal element 13 comprises a plurality of second conductor bodies 25a, 25b, 25c, 25d for the electrical connection of the conducting strips 3a, 3b, 3c, 3d, 3e, 3f, 3g, 3h to one another, so that two overlapped strips are crossed by current going the opposite way to each other, with the advantages described above of cancelling out of the electromagnetic field generated.

More specifically, the second terminal element 13 comprises two half-elements 26, 27 fixed to one another with screws 28 so as to surround the opposite first face 10 and second face 11 of the flexible band 2 at the second end 6.

The second conductor bodies 25a, 25b, 25c, 25d are housed in respective second seats 29 foreseen in the half-elements 26, 27 as can be seen in FIG. 5. The second conductor bodies 25a, 25b, 25c, 25d consist, for example, of metallic blocks.

The half-elements 26, 27 of the second terminal element 13 are made, for example, from material like plastic, or another material of equivalent mechanical and electrical insulation characteristics.

FIG. 4 schematically illustrates the arrangement of the first conductor bodies 14a, 14b, 14c, 14d, 14e and of the second conductor bodies 25a, 25b, 25c, 25d and their connection to the conducting strips 3a, 3b, 3c, 3d, 3e, 3f, 3g, 3h, so as to obtain an electric circuit in which the directly overlapped strips are crossed by electric current going the opposite way. In order to make such a connection, the insulating sheets 8, 9 are partially removed at the respective terminal portions, so as to uncover the terminal ends of all of the strips 3a, 3b, 3c, 3d, 3e, 3f, 3g, 3h.

A first conductor body 14a, i.e. the one arranged on the left in FIG. 4 and of equal width to that of a conducting strip, i.e. of the single type, is directly connected to one of the electric cables 21, as can also be seen in FIG. 2, which in FIG. 4 is schematised with an arrow. By selecting a conventional direction of flow of the electric current, it can be seen that the current therefore crosses the strip 3a and, through the second conductor body 25a, proceeds through the strip 3b, which is placed under the strip 3a. From here, the current passes through the first conductor body 14b, this time of the double type, to the strip 3c, and then, through the second conductor body 25b, to the strip 3d. Hereafter, the electrical connection is continued by the first double conductor body 14c, which connects the strip 3d to the strip 3e; the current then continues, through the second conductor body 25c, to the strip 3f, arranged below. Finally, in an intuitive manner, the current crosses the first conductor body 14d, of the double type, the strip 3g, the second conductor body 25d, the strip 3h and finally the first single conductor body 14e, to which the other of the electrical cables 22 is connected, this also being schematically represented as an arrow. The electric circuit is thus closed.

The conducting strips 3a, 3b, 3c, 3d, 3e, 3f, 3g, 3h, of substantially smaller width than that of the flexible band 2, therefore have a strength—which obviously depends upon the cross section of the strip itself—that is relatively high and suitable, with the mains power supply voltage, for determining an optimal thermal power, per square metre of surface, to give a feeling of comfort for the people that occupy the room in which the device is installed.

Purely as an example for clarifying purposes, let us consider that the electrical power necessary to heat a room to make it comfortable was estimated to be about 50 W per square metre.

As known, the electrical power is the product of the voltage by the electric current: since the voltage is mains voltage, the electrical current must be reduced to ensure the optimal power value. This result is obtained by using conducting strips 3a, 3b, 3c, 3d, 3e, 3f, 3g, 3h of reduced width and suitable length, and therefore of high resistance.

In particular the length of the strips 3a, 3b, 3c, 3d, 3e, 3f, 3g, 3h is selected and sized based on the surface of the room to be heated.

The overall number of strips 3a, 3b, 3c, 3d, 3e, 3f, 3g, 3h included in one flexible band 2, since they are connected in series, is also selected in relation to the surface of the room to be heated, since the overall resistance of the device depends precisely upon the number of strips connected in series.

It has thus been seen how the invention achieves the proposed purposes.

The heating device according to the invention makes it possible, with a simple mains power supply, to supply the electrical power, to be dissipated in the room in the form of heat, which is optimal to give the feeling of comfort to the people present in the room in which it is installed.

This result is obtained using conducting strips of substantially smaller width than that of the flexible band, suitably sized to obtain a circuit of overall resistance suitable for dissipating the desired thermal power.

At the same time, however, the presence of a flexible support band of “standard” width, which is manageable, strong and insulating, makes it possible to install the device in a simple and effective manner in any room, even by unspecialised personnel.

Moreover, the electrical connection between the strips takes place through metallic blocks stably housed in respective seats: such a connection is therefore clean, reliable and without cables, clamps and other means that are awkward to mount and subject to wear over time.

Another embodiment of the device according to the invention is represented in FIGS. 6, 7, 8.

In the description of this embodiment, just like in the relative drawings, the same reference numerals of the description of the previous embodiment are used to indicate the corresponding parts.

With respect to the embodiment described earlier, the present one differs in the method of connection of the conducting strips 3a, 3b, 3c, 3d, 3e, 3f, 3g, 3h.

In greater detail, said conducting strips 3a, 3b, 3c, 3d, 3e, 3f, 3g, 3h, in the present embodiment, are connected in parallel in sets of two.

Indeed, as can be seen for example in the diagram of FIG. 8, the strips 3a and 3d, which are located directly adjacent on the same face of the flexible band, are connected in parallel through a first conductor body 14f at the first end 5 of the flexible band 2, on the first outer face 10 thereof.

In the same way, said strips 3a and 3d are connected in parallel at the second end 6 of the flexible band 2, again on the first outer face 10, through a second conductor body 25e. The same second conductor body 25e connects the two underlying strips 3b, 3c, at the second outer face 11 of the flexible band.

Said strips 3b, 3c are in turn connected, at the first end 5, through a further second conductor body 14g, which extends even up to the subsequent strips 3f, 3g, which thus are in turn connected in parallel.

The connection in parallel of said strips 3f, 3g is completed, at the second end 6, through another second conductor body 25f; the latter also connects the remaining strips 3e,3h in parallel, which are also connected by a further first conductor body 14h.

The first conductor bodies 14f, 14h are connected directly to the mains.

The solution of the connection in parallel of the strips 3a, 3b, 3c, 3d, 3e, 3f, 3g, 3h makes it possible to obtain an equivalent resistance, of the entire electric circuit, which is substantially lower than that of the previous embodiment, in which the connection is, on the other hand, in series.

Obtaining a lower equivalent resistance makes it possible to obtain a greater current that passes through the circuit, and therefore a greater thermal power that can be dissipated into the surface unit.

The definition of the length of the flexible band 2, and therefore of the strips 3a, 3b, 3c, 3d, 3e, 3f, 3g, 3h, makes it possible to determine with a certain degree of precision the thermal power that the band is able to supply. Considering the fact that the band 2 is usually arranged under the floor to heat a room of a certain area, it is possible to cut to size the band 2 necessary to obtain the desired thermal power per square metre, for example 50 W/m², as stated earlier.

With respect to the previous embodiment, however, the present embodiment with the connections in parallel makes it possible to use less band for the same thermal power that can be obtained.

Installation is therefore faster, easier and more cost-effective, even for people untrained in the field.

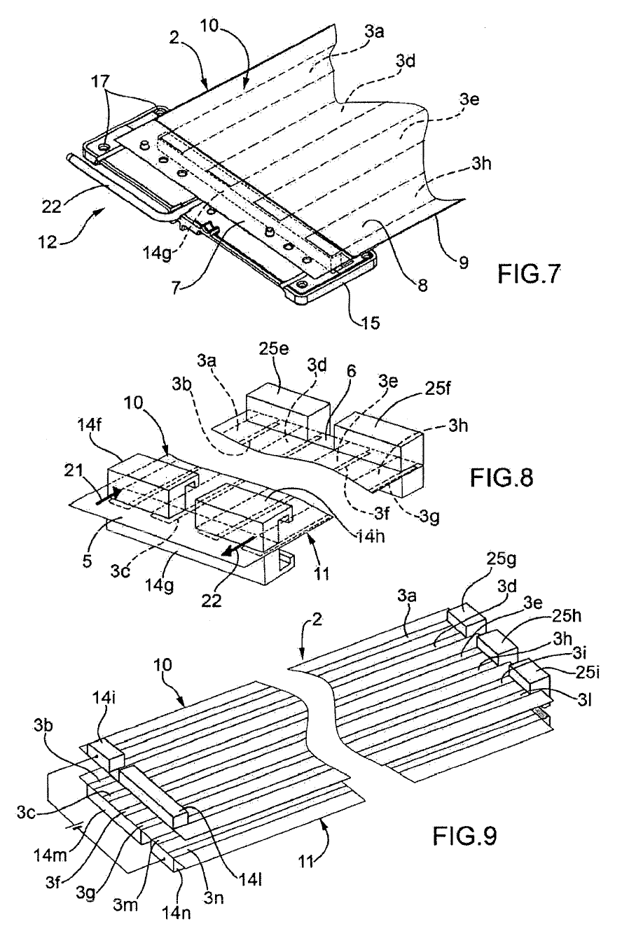

As can also be seen in FIGS. 6, 7, the remaining components of the device—in other words mainly the first terminal element 12 and the second terminal element 13—are substantially identical to those described in the previous embodiment. Since, however, there are first conductor bodies 14f, 14g, 14h and second conductor bodies 25e, 25f of different dimension to those of the previous embodiment, correspondingly the first and second seats 18, 29 foreseen in the first terminal element 12 and in the second terminal element 13 must consequently be sized so as to receive them. It should also be noted that it is possible to standardise the devices to be placed on the market in relation to their length, i.e. so as to be able to satisfy the heating requirements of all rooms of the most common homes or buildings.

For example, there can be three different lengths of the flexible bands 2, which are able to supply the necessary thermal power per square metre for all rooms that are commonly found in buildings.

Such three standard lengths can obviously be combined in a modular fashion in order to meet any requirement, in an extremely practical and versatile manner.

Such bands 2, as described, can be provided with terminal connection elements 12, 13 arranged at the ends 5,6, or else there can be intermediate connection elements, to be applied at certain points along the band 2 itself, to obtain other personalised methods of electrical connection, and yet other results.

Another embodiment of the device according to the invention is illustrated in FIG. 9.

In FIG. 9 the flexible band 2 is illustrated without the insulating sheets 8, 9, for the sake of ease of understanding.

In this embodiment, the band 2 comprises six strips for each face 10, 11, i.e. in total twelve strips: then the four strips 3i, 3l, 3m, 3n represented in FIG. 9 are added.

The method of connection of the strips 3a-3n, i.e. the connection in parallel in sets of two, is exactly the same as described in the previous embodiment of FIGS. 6, 7, 8, for which reason it will not be repeated in detail.

In order to make such a connection, further first conductor bodies 14i, 14l, 14m, 14n and further second conductor bodies 25g, 25h, 25i are used, sized and arranged as illustrated intuitively in FIG. 9.

The presence of a greater number of strips 3a-3n makes it possible to obtain a greater versatility of use, since various electrical connections can be made between the individual strips 3a-3n, so as to obtain different equivalent resistances in relation to the different application requirements.

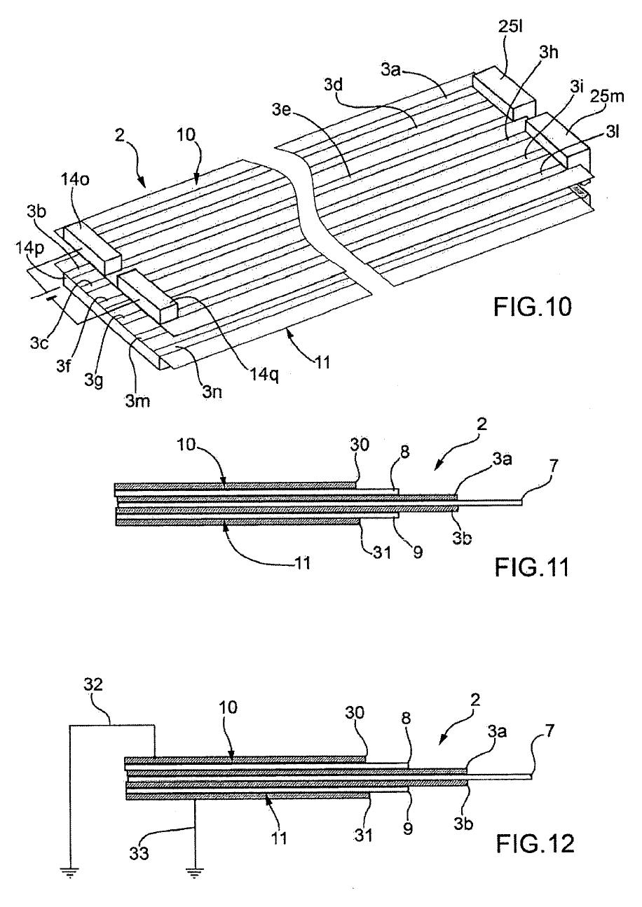

As confirmation of this, a further embodiment of the device according to the present invention is illustrated in FIG. 10.

In this embodiment, the band 2 is identical to the one of the previous embodiment—FIG. 9—i.e. it is equipped, for every face 10, 11, with six strips, for a total of twelve strips 3a-3n.

With respect to the previous embodiment, in this one of FIG. 10 only the electrical connections between the strips 3a-3n are different, so as to obtain a different equivalent resistance with respect to those of the previous embodiments.

In greater detail, the strips 3a-3n are connected, this time, in parallel in sets of three, as can clearly be seen in FIG. 10.

For this purpose, there are first conductor bodies 14o, 14p, 14q and second conductor bodies 25l, 25m positioned and sized so as to carry out the desired method of connection, as illustrated in FIG. 10.

The equivalent resistance of the band 2 of the present embodiment is different from that of the previous embodiment.

More generally, the strips 3a-3n can be connected, at the ends 5, 6 of the band 2, in parallel in groups of predefined number.

In another embodiment, not represented in the figures, the twelve strips 3a-3n can all be connected in series with one another, in a totally equivalent way to what is schematically illustrated in FIG. 4.

It is clear, therefore, that as the number of strips present in the band 2 increases, the possibilities of obtaining different equivalent resistances, and therefore different thermal powers able to be dissipated by a band 2, for the same length, increases. In this way the versatility of the device is further increased: one band 2, made with standardised technologies, can be used, thanks to the possibility of varying the methods of electrical connection between the strips 3a-3n, to obtain thermal powers per square metre that are even very different from one another.

Thus, by suitably selecting the type of connection between the strips 3a-3n and the length of the band 2, devices are made with variable thermal power having a very large number of possibilities, so as to meet any possible requirement.

There can be other forms of connection, between the strips 3a-3n, consisting of different series-parallel combinations, according to the specific requirements. Another embodiment of the device is represented, in a detailed section thereof, in FIG. 11.

In particular, FIG. 11 illustrates the band 2 at one of its ends 5, 6, irrespectively, with the various layers partially removed for the sake of ease of understanding.

With respect to the band 2 described in the previous embodiments, in the present one there are two metallic films 30, 31 that at least partially or even completely cover the band 2 at the respective outer faces 10, 11. The two metallic films 30, 31 can be made, for example, from aluminum, or else from another metallic material with suitable properties.

With this provision, the band is, first of all, made fire-retardant, even when there is a flame in direct contact with the surface.

Secondly, since the heat emitted by the strips 3a-3n is not perfectly uniform in the transversal direction with respect to the band 2, precisely due to the discontinuities between conductor material and insulating material, the presence of the metallic films 30, 31 makes it possible to make the diffusion of heat by the device more even and uniform.

Yet another embodiment of the device according to the present invention is illustrated, in a detailed section, in FIG. 12.

This embodiment is absolutely identical to the previous one of FIG. 11, and only differs in that the metallic films 30, 31 are connected to earth through respective electrical connections 32, 33.

Thanks to such a connection to earth, any accidental contact of metallic, liquid or other bodies with the films 30, 31 determines the instantaneous actuation of the protections foreseen in electrical systems compliant with current legal requirements.

For example, if in the installation step of the device or in any subsequent maintenance or restructuring intervention, the metallic films 30, 31 are touched by metallic bodies—for example tools or other—there is no danger to the workers, since the connection to the electrical mains is immediately interrupted.

Furthermore, this advantage makes it possible to install the device even in locations where there is a large amount of water, such as swimming pools and the like: a possible spillage or leak of liquid towards the device causes the instant interruption of the connection to the electrical mains. This makes the device even more versatile and suitable for any type of application.

The present invention has been described according to preferred embodiments, but equivalent variants can be devised without departing from the scope of protection offered by the following claims.

What is claimed is:

1. Heating device, comprising a flexible band provided with laminar conductor means crossed by current and suitable for diffusing heat into the environment and laminar insulating means associated with said laminar conductor means, wherein said conductor means comprise a plurality of conducting strips, of smaller width than that of said flexible band, electrically connected to one another.

2. Heating device according to claim 1, wherein said conducting strips are electrically connected in series with one another at the ends of said flexible band.

3. Heating device according to claim 1, wherein said conducting strips are electrically connected in parallel at the ends of said flexible band.

4. Heating device according to claim 1, wherein said conducting strips are electrically connected in parallel in groups of predefined number at the ends of said flexible band.

5. Heating device according to claim 1, wherein said conducting strips are electrically connected, at the ends of said flexible band, according to series-parallel combinations.

6. Heating device according to claim 1, wherein said conducting strips are in overlapping sets of two.

7. Heating device according to claim 1, comprising a first terminal element for the electrical connection of said conducting strips fixed at a first end of said flexible band.

8. Heating device according to claim 4, comprising a second terminal element for the electrical connection of said conducting strips fixed at the second end of said flexible band.

9. Heating device according to claim 7, wherein said first terminal element comprises a plurality of first conductor bodies for the electrical connection of said conducting strips, so that two overlapping strips are crossed by current going opposite ways to one another.

10. Heating device according to claim 8, wherein said second terminal element comprises a plurality of second conductor bodies for the electrical connection of said conducting strips to one another, so that two overlapping strips are crossed by current going opposite ways to one another.

11. Heating device according to claim 7, wherein said first terminal element comprises a first and a second half-shell fixed to one another so as to surround the opposing first face and second face of said flexible band at said first end.

12. Heating device according to claim 9, wherein said first conductor bodies are housed in respective first seats foreseen in said first half-shell and/or said second half-shell.

13. Heating device according to claim 8, wherein said second terminal element comprises two half-elements fixed to one another so as to surround the opposite first face and second face of said flexible band at said second end.

14. Heating device according to claim 10, wherein said second conductor bodies are housed in respective second seats foreseen in said half-elements.

15. Heating device according to claim 9, wherein at least two of said first conductor bodies housed in said first terminal element, or at least two second conductor bodies housed in a second terminal element are connected to electric power supply means.

16. Heating device according to claim 1, wherein said flexible band comprises, on at least one of a first outer face and second outer face, at least one metallic film.

17. Heating device according to claim 1, wherein said flexible band comprises two metallic films on a first outer face and on a second outer face, respectively.
